(19) United States
(12) Patent Application Publication
(10) Pub. No.: US 2007/0168072 A1
(43) Pub. Date: Jul. 19, 2007

(54) Apparatus and a management method for a flow production line system

(76) Inventor: Wei Wang, Tucheng City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/331,105

(22) Filed: Jan. 13, 2006

(51) Int. Cl. G06F 19/00

(52) U.S. Cl. 700/115

(57) ABSTRACT

The present invention provides an apparatus and a management method for a flow production line system. The apparatus for the flow production line system includes a plurality of flow production lines, a plurality of display devices for showing correlate data, a plurality of bar-code scanners arranged at the end of the flow production lines for scanning a production code respectively and a plurality of production-line computers coupling with the display device and the bar-code scanners respectively for gathering and recording statistic data electronically. The management method for the flow production line system includes following steps: (1). while a production is produced and conveyed to the end of the flow production line, the bar-code scanner scans the production code of the production; (2). after scanning the production code, the production-line computer gathers and updates the correlate data received from the bar-code scanner and provides the correlate data to the display device; and (3). the display device refreshes and shows the correlate data while the correlate data is updated.

### BACKGROUND OF THE INVENTION

1. Field of the Invention

The invention relates to a management method for a flow production line system, and more specifically to a management method for the flow production line system that comprises a plurality of display devices for showing correlate data, a plurality of bar-code scanner for scanning production code and a plurality of computer for recording and gathering statistic the correlate data.

2. The Related Art

Since a flow production line system is developed, the flow production line system is popular in manufacturing industry because the flow production line system has high producing efficient. So that, a plurality of manufacturing industry adopt the flow production line system. The flow production line system includes a plurality of flow production lines. According to a management method for the flow production line system in early days, statistic data and correlate data of the productions produced from each flow production line are gathered and managed via a plurality of sheets. The sheets record a large of amount of data which has to be kept for a long period of time. The management method for the flow production line system in early days includes following defects:
(1). A large amount of the sheets are squandered;
(2). Gathering the statistic data and managing the correlate data for the production line system from each flow production line are difficult and complex and easy to make mistakes;
(3). The sheets are easy to be lost and then the data of the flow production line system would not continue; and
(4). According to the defects described above, the management method for the flow production line system in early days leaves a bad impression on visitors.

In another management method for the flow production line system provides a board. For example, the correlate data of the flow production line system is gathered and filled on the board, such as a blackboard, a whiteboard, etc. And then, a producing procedure of the flow production line system is managed according to the correlate data gathered from each flow production line. Although the method for gathering statistic data and managing the correlate data of the flow production line system via the board solves the defects described above, the method occurs other defects. For example, after using the board for a long time, the correlate data written on the board is blurred. The board only displays the correlate data written thereon. When new correlate data occurred, the board has to be cleared and then the new correlate data is written on the board. All of the correlate data must be recorded by other device before cleared, otherwise, the correlate data would be lost. And then, managing the producing procedure of the flow production line system via the board is not convenient. Moreover, changing new boards causes further expense.

With rapid development of electronic technology, another management method for the flow production line system is provided with an electronic board device. The electronic board device comprises an electronic board and a counter. Each flow production line is provided with at least one electronic board and one counter and the electronic board electronically couples with the counter. The electronic board displays total amount of the production produced from the flow production line via the counter. And then, the counter provides the total amount of the production to the electronic board. The electronic board displays the total amount of the production. The electronic board device is not able to save, manage and gather statistic data of every flow production line. Since every electronic board is independent, it is difficult to manage the whole correlate data produced from all of the flow production lines. So that, the electronic board device is not able to satisfy with manufacturing industry nowadays.

### SUMMARY OF THE INVENTION

An object of the present invention is to provide an apparatus for a flow production line system. The apparatus for the flow production line system comprises a plurality of flow production lines, a plurality of display devices for showing correlate data of management sheets and electronic statistic sheets, a plurality of production-line computers for gathering statistic and recording the correlate data of management sheets and electronic statistic sheets and a plurality of bar-code scanners for scanning a production code. The display device and the bar-code scanner are arranged at the end of each of the flow production lines respectively. The production-line computer electrically couples with each display device and each bar-code scanner.

A further object of the present invention is to provide a management method for the flow production line system. The management method for the flow production line system comprises following steps:
(1). While a production is produced and conveyed to the end of the flow production line, the bar-code scanner scans a production code of the production;
(2). After scanning the production code of the production, the production-line computer receives a signal and updates the correlate data of the management sheets and the electronic statistic sheets. And then, the correlate data of the management sheets and the electronic statistic sheets are shown on a monitor of the production-line computer and provided to the display device; and
(3). The display device refreshes and shows the correlate data of the management sheets and the electronic statistic sheets immediately while the correlate data of the management sheets and the electronic statistic sheets is updated.

### BRIEF DESCRIPTION OF THE DRAWINGS

The present invention will be apparent to those skilled in the art by reading the following description of a preferred embodiment thereof, with reference to the attached drawings, in which:

FIG. 1 illustrates an apparatus for a flow production line system according to a first embodiment of the present invention.

FIG. 2 illustrates the apparatus for the flow production line system according to a second embodiment of the present invention.

### DETAILED DESCRIPTION OF THE PREFERRED EMBODIMENT

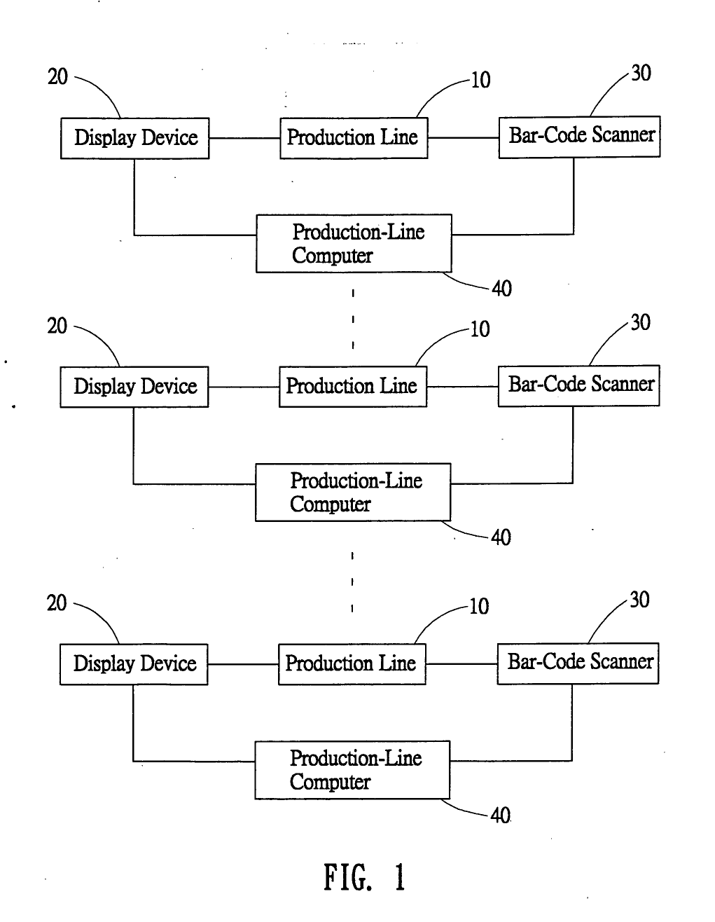

Please refer to FIG. 1, which shows a preferred embodiment of an apparatus and a management method for a flow production line system. The apparatus for the flow production line system comprises a plurality of flow production lines 10, a plurality of display devices 20, a plurality of production-line computers 40 and a plurality of bar-code scanners 30. The display device 20 and the bar-code scanner 30 are arranged at the end of each of the flow production lines 10 respectively. The production-line computer 40 electrically couples with the display device 20 and the bar-code scanner 30.

The production-line computer 40 comprises a controlling interface. The controlling interface identifies different production code scanned by the bar-code scanner 30 and then gathers statistic correlate data received from the bar-code scanner 30, for example, total amount of the production, right amount of the production and error amount of the production are gathered according to the different production code scanned by the bar-code scanner 30.

The controlling interface transfers the correlate data to a plurality of electronic management sheets and a plurality of electronic statistic sheets, for example, production-line producing capability sheets, production-line daily sheets, production-line weekly sheets and production-line monthly sheets, etc. The production-line computer 40 records and updates the correlate data of the electronic management sheets and the electronic statistic sheets. For example, the bar-code scanner 30 scans the production code of the production once, the original data of the total amount of the production pluses one to form an updated data. The updated data is refreshed and shown on a monitor of the production-line computer 40. The production-line computer 40 provides the correlate data of the electronic management sheets and the electronic statistic sheets to the display device 20.

The display device 20 refreshes and shows the correlate data of the electronic management sheets and the electronic statistic sheets received from the production-line computer 40 while the correlate data of the electronic management sheets and the electronic statistic sheets is updated.

An authorized people is authorized to enter the controlling interface of production-line computer 40. Of course, different people has different authorization to operate the controlling interface to execute necessary function, for example, the authorized people is able to look up and edit the correlate data of the electronic management sheets and the electronic statistic sheets.

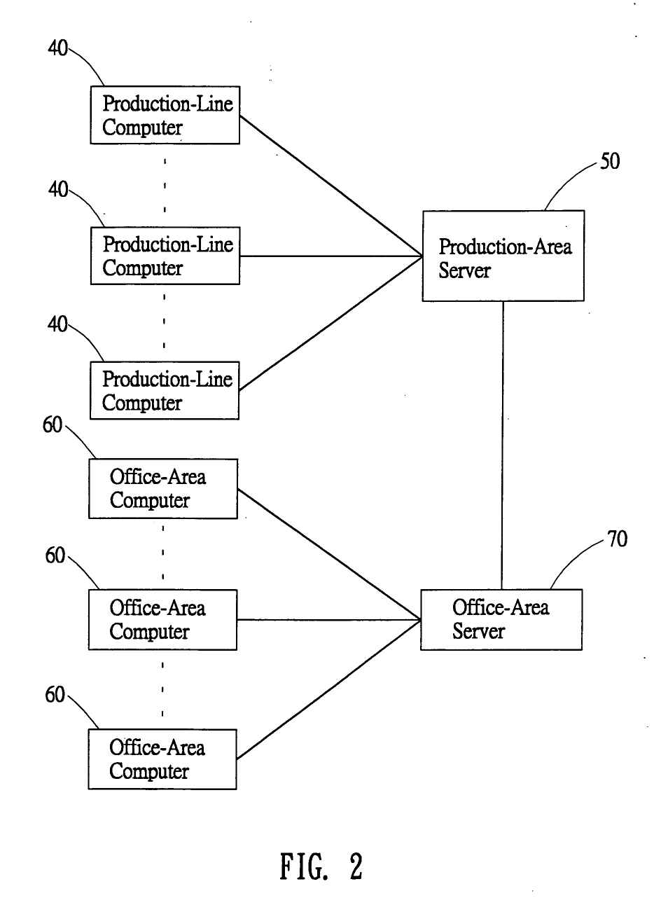

Please refer to FIG. 2. The apparatus for the flow production line system further comprises a production-area server 50, a plurality of office-area computers 60 and a office-area server 70. The production-area server 50 electronically couples with the production-line computer 40. The office-area server 70 electronically couples with the production-area server 50 and the office-area computer 60 electronically couple with the office-area server 70.

The production-line computer 40 provides the correlate data of the electronic management sheets and the electronic statistic sheets to the production-area server 50. The production-area server 50 comprises a controlling interface that receives and identifies the correlate data of the electronic management sheets and the electronic statistic sheets of each flow production line 10 respectively. The controlling interface gathers statistic the correlate data of the electronic management sheets and the electronic statistic sheets received from the production-line computer 40.

Furthermore, the controlling interface transfers the correlate data of the electronic management sheets and the electronic statistic sheets to a plurality of total amount electronic sheets, for example, total producing capability sheets, total daily sheets, total weekly sheets and total monthly sheets, etc. The correlate data and the total amount electronic sheets are shown on the monitor of the production-area server 50. The production-area server 50 records and updates the correlate data and the total amount electronic sheets.

The authorized people is authorized to enter the controlling interface of the production-area server 50. Of course, different people has different authorization to operate the controlling interface to execute necessary function, for example, the authorized people is able to seek and modify the correlate data and the total amount electronic sheets.

The office-area server 70 and the office-area computer 60 comprise a controlling interface respectively. Relevant data, such as a producing target, an engineering sheet, a technology sheet, a management sheet, a policy decision notice, etc are input in the controlling interface of the office-area computer 60 and the controlling interface of the office-area server 70.

The authorized people is authorized to enter the controlling interface of the office-area computer 60 and the controlling interface of the office-area server 70. Of course, different people has different authorization to operate the controlling interface of the office-area computer 60 and the controlling interface of the office-area server 70 to execute necessary function, for example, the producing target and the policy decision notice are made up and input in the controlling interface.

The authorized people has the right to access the correlate data of the electronic management sheets and the electronic statistic sheets that recorded in the production-line computer 40 and the production-area server 50 via the office-area server 70 and the office-area computer 60, for example, a supervisor is able to look up and edit the correlate data of the electronic management sheets and the electronic statistic sheets.

Furthermore, the correlate data of the electronic management sheets and the electronic statistic sheets recorded in the production-line computer 40 and the production-area server 50 are understood conveniently and immediately via the apparatus for a flow production line system of the present invention.

While relevant data is input in the controlling interface of the office-area computers 60 and the office-area server 70, the authorized people has the right to access the relevant data via the production-line computers 40 and the production-area server 50 for editing and managing.

Furthermore, the relevant data is shown on the display device 20 via the production-line computer 40 and the relevant data is notified conveniently and immediately via the apparatus for a flow production line system of the present invention.

The management method for a flow production line system of the present invention comprises flowing steps:
(1). While a production -is produced and conveyed to the end of the flow production line 10, the bar-code scanner 30 scans the production code of the production;
(2). After scanning the production code of the production, the controlling interface of the production-line computer 40 receives a signal and updates the correlate data of management sheets and the electronic statistic sheets. The correlate data of management sheets and the electronic statistic sheets are shown on the monitor of the production-line computers 40. The production-line computer 40 provides the correlate data of management sheets and the electronic statistic sheets to the display device 20; and
(3). The display device 20 refreshes and shows the correlate data of management sheets and the electronic statistic sheets immediately while the correlate data of management sheets and the electronic statistic sheets is updated.

The step (1) comprises following performed methods:
(A). If the production is provided with the production code and the bar-code scanner 30 arranged at the end of the flow production line 10 and set to auto-scanning mode, the bar-code scanner 30 scans the production code of the production automatically while the production is produced and conveyed to the end of the flow production line 10, then the step (1) is performed;
(B). If the production is provided with the production code and the bar-code scanner 30 set to manual-scanning mode, an operator manually uses the bar-code scanner 30 to scan the production code of the production once while the production is produced and conveyed to the end of the flow production line 10, then the step (1) is performed; and
(C). If the production is not provided with the production code and the bar-code scanner 30 set to manual-scanning mode, a production code is arranged at the end of the flow production line 10. While the production is produced and conveyed to the end of the flow production line 10, the operator manually uses the bar-code scanner 30 to scan the production code once, then the step (1) is performed.

The step (2) comprises following conditions:
(A). If the signal and the presetting code are the same, the original right amount of the production and the original total amount of the production pluses one to form an updated data respectively. The updated data is gathered and then recorded in the production-line computer 40; and
(B). If the signal and the presetting code are different, the original error amount of the production and the original total amount of the production pluses one to form an updated data respectively. The updated data is gathered and then recorded in the production-line computer 40.

The management method for a flow production line system of the present invention further comprises flowing steps:
(1). While the relevant data is made up and input in the controlling interface face of the office-area computer 60, the relevant data is shown on the monitor of the production-line computer 40 and the display device 20;
(2). According to the relevant data, a producing procedure of the flow production line system is arranged and managed;
(3). During the producing procedure of the flow production line system, the correlate data is input in the production-line computer 40 and provided to the production-area server 50;
(4). The controlling interface of the production-area server 50 gathers and records the correlate data in the production-area server 50. The controlling interface of the production-area server 50 transfers the correlate data to the total amount electronic sheets and then records the total amount electronic sheets in the production-area server 50;
(5). The total amount electronic sheets is understood via the production-line computer 40, the production-area server 50, the office-area computer 60 and the office-area server 70; and
(6). According to the total amount electronic sheets, new relevant data is made up and input in the controlling interface face of the office-area computer 60 and then step (1) is performed.

In the above, an embodiment of the present invention has been described, but the present invention is not limited to the embodiment described above. It is needless to say that various types of alterations can be performed without departing from the essence of the present invention.

What is claimed is:

1. An apparatus for a flow production line system comprising:
a plurality of flow production lines;
at least one display device arranged at one end of said flow production line;
at least one code-bar scanner arranged at the other end of said flow production line;
at least one computer electronically coupling with said display device and said code-bar scanner;
said computer comprising a controlling interface, said controlling interface identifying different production code scanned by said bar-code scanner and received from said bar-code scanner and then gathering statistic and transferring said correlate data to a plurality of electronic sheets, said computer recording and updating said correlate data of said electronic sheets and providing said correlate data of said electronic sheets to said display device; and
said display device showing said correlate data of said electronic sheets while said correlate data of said electronic sheets is updated.

2. The apparatus for a flow production line system as claimed in claim 1, further comprising:
at least one production-area server electronically coupling with said computer;
at least one office-area server electronically coupling with said production-area server;
at least one office-area computer electronically coupling with said office-area server;
said production-area server comprising a controlling interface, said computer providing said correlate data of said electronic sheets to said production-area server, said controlling interface gathering and transferring said correlate data of said electronic sheets to a plurality of total amount electronic sheets, said production-area server recording said total amount electronic sheets; and
said office-area server and said office-area computer comprising a controlling interface respectively, said controlling interface being input relevant data respectively.

3. A management method for a flow production line system comprising the following steps:
(1) While a production is produced and conveyed to the end of said flow production line, said bar-code scanner scanning said production code of said production;
(2) After scanning said production code of said production, said controlling interface of said production-line computer receiving a signal and updating said correlate data of said electronic sheets, said correlate data of said electronic sheets being shown on a monitor of said production-line computers and being provided to said display device; and
(3) said display device refreshing and showing said correlate data of said electronic sheets immediately while said correlate data of said electronic sheets being updated.

4. The management method for a flow production line system as claimed in claim 3, wherein said step (1) comprising following performed methods:
(1) If said production is provided with said production code and said bar-code scanner is arranged at the end of said flow production line and set to auto-scanning mode, said bar-code scanner scanning said production code of said production automatically while said production are produced and conveyed to the end of said flow production line;
(2) If said production is provided with said production code and said bar-code scanner set to manual-scanning mode, said bar-code scanner scanning said production code of said production manually while said production are produced and conveyed to the end of said flow production line; and
(3). If said production is not provided with said production code, said bar-code scanner being set to manual-scanning mode and a production code being arranged at the end of said flow production line, said bar-code scanner scanning said production code manually while said production is produced and conveyed to the end of said flow production line.

5. The management method for a flow production line system as claimed in claim 3, wherein said step (2) comprising following conditions:
(1). If said signal and said presetting code are the same, a original right amount of said production and a original total amount of said production pulsing one to form an updated data respectively, said updated data being gathered and recorded in said computer; and
(2). If said signal and said presetting code are different, a original error amount of said production and said original total amount of said production pulsing one to form said updated data respectively, said updated data being gathered and recorded in said computer.

6. The management method for a flow production line system as claimed in claim 3, further comprising the following steps:
(1). while said relevant data is input in said controlling interface face of said office-area computer, said relevant data being shown on the monitor of said production-line computer and said display device;
(2). according to said relevant data, a producing procedure of said flow production line system being managed and arranged;
(3). during said producing procedure of said flow production line system, said correlate data being input in said computer and provided to said production-area server;
(4). said controlling interface of said production-area server gathering and recording said correlate data in said production-area server, said controlling interface of production-area server transferring said correlate data to said total amount electronic sheets and then recording said total amount electronic sheets in said production-area server;
(5). said total amount electronic sheets being understood via said production-line computer, said production-area server, said office-area computer and said office-area server; and
(6). according to said total amount electronic sheets, new correlate data being input in said controlling interface face of said office-area computer.
